(19) United States
(12) Patent Application Publication
(10) Pub. No.: US 2015/0365417 A1
(43) Pub. Date: Dec. 17, 2015

(54) NETWORK MANAGEMENT ACCESS BASED PREVIOUS REGISTRATION OF USER DEVICE

(71) Applicant: Hewlett-Packard Development Company, L.P., Houston, TX (US)

(72) Inventor: Saro Chandra BHOOSHAN, Bangalore (IN)

(21) Appl. No.: 14/764,084

(22) PCT Filed: Nov. 12, 2013
(86) PCT No.: PCT/US2013/069554

§ 371 Date: Jul. 28, 2015

(30) Foreign Application Priority Data
Jan. 31, 2013 (IN) 277/DEL/2013

(51) Int. Cl. H04L 29/06

(52) U.S. Cl. CPC H04L 63/101; H04L 63/0876

(57) ABSTRACT

A user device may be self-registered in a network where it may be determine if the user device was previously registered and marked for deletion; and if the user device was previously registered and marked for deletion, access to the network may be granted or denied depending on whether the user device was previously registered and marked for deletion.

### BACKGROUND

User-oriented processing and communications devices, such as personal computers, laptop computers, cell phones, PDAs, printers, and similar devices are frequently connected to computer networks and/or communications networks. These may include corporate, educational, government, public access and other networks.

Network connectivity entails not just a physical connection, such as a hardwired coupling or a coupling via a wireless connection, but also software-based authorization to access network resources. Such authorized access typically provides the ability for a user device to communicate over the network, access and use other devices on the network such as printers, and possibly to access various database and other information resources on the network, such as e-mail. In order to ensure the security of a network, only authorized network users and devices should be permitted to obtain access to network resources.

### BRIEF DESCRIPTION OF THE DRAWINGS

Features of the present disclosure are illustrated by way of example and not limited in the following figure(s), in which like numerals indicate like elements, in which:

FIG. 1 shows an example functional block diagram of an environment in which a network device for managing access to a network by a user device may be implemented, according to an example of the present disclosure;

FIG. 2 depicts an example flow diagram of a method for managing access to a network, according to an example of the present disclosure;

FIG. 3 depicts an example flow diagram of a method for enabling a user to self-register a user device into a database of authorized users to access a network, according to an example of the present disclosure;

FIG. 4 depicts an example flow diagram of a method for ongoing management of a user and user device already granted access to a network, according to an example of the present disclosure;

FIG. 5 depicts an example database of authorized users, according to an example of the present disclosure;

FIG. 6 depicts an example flow diagram of a self-registration method, according to an example of the present disclosure; and

FIG. 7 illustrates an example schematic representation of a computing device, which may be employed to perform various functions of devices depicted in FIG. 1, according to an example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on.

Given a network of resources, communication devices such as personal computers, PDAs, cell phones, laptops, and similar devices may frequently join and leave a network. A network may include switches, routers, servers, desktops, databases, etc., which may provide services like internet access, access to services e.g., e-mail, etc. Network security plays important role in determining which device is authenticated to join the network and which resources it is authorized to access. Establishing, maintaining, monitoring and controlling network access rights, has become a daunting task for a network administrator. Existing network access solutions may be too complex to adopt, or time consuming, or most of the features of the solution may not be put to optimal use. Once users and user devices are registered and authorized to access a network and network resources, it is difficult to detect when an authorized device has been spoofed by an unauthorized device and/or user, thereby leaving the network and network resources open to non-authorized users.

Disclosed herein are methods, systems, computer-readable mediums storing program instructions, apparatuses, etc., for managing access to a network that requires a substantially minimal amount of administrative overhead. In other words, the methods and apparatuses disclosed herein substantially remove the need for large IT staffs or external consultants. The NAC implementation disclosed herein is referred to as Simplified Network Access Control (SNAC), but other names may be employed as well. As disclosed herein, SNAC may simplify NAC for both the client (end user) and the system and/or domain administrators. According to an example, SNAC may simplify NAC for clients by providing a client service portal for self-registration, which allows clients to register for access to the network with the appropriate access rights and quality of service. In addition, SNAC may simplify NAC for the administrator as well, by substantially removing the need for learning and mastering a number of external technologies:
Does not need to become an expert in RADIUS servers.
Does not need to become an expert in directory services (e.g. Active Directory).
Does not need to become an expert in 802.1X technology.

Additionally, in at least some NAC implementations, the administrator is typically required to perform the initial and ongoing maintenance of all the clients that want access to the network. Typically, there is an initial bulk configured process, followed by ongoing updating (adding new clients, deleting old clients, updating clients for changes to access rights). The SNAC implementation disclosed herein removes this burden from the administrator through the self-registration capability and automated updating of the users' access rights. In addition, through use of a separate database of authorized users, the SNAC implementation disclosed herein enables for network access control to be based upon information contained in the directory of active network users, such as, the Active Directory, without making changes to the Active Directory.

The registration process may include a check to see if the user device was previously registered and, if so, whether the user device was marked for deletion. If the user device was previously registered and marked for deletion, and a new user, different from the user that previously registered the user device, is trying to newly register the user device, access to the network may be denied. This process may maintain security in the network by ensuring that only authorized users and user devices have access to the network and the network resources.

According to an example, the user self-registration operation disclosed herein enables the user to self-populate the database of authorized users if the user is able to be verified in the directory of active network users. The active network users contained in the directory of active network users are users who exist in the existing Domain. In this regard, the active network users have been granted access rights to the network, whether or not those access rights are actually being exercised by the active users, that is, whether or not those users have user devices connected to the network. A user is typically understood to be a person, though a user may be some other kind of entity. A user device is typically understood to be an electronic computer or computing device, or other electronic information device, and/or a communications device, such as a cell phone. Other types of electronic devices pertaining to data or information processing, such as printers or PDAs, may be user devices as well.

The directory of active network users includes data of the types typically used to define and authorize a user who may be allowed network access. Such information may include, for example and without limitation, a user name, a user company, a user group or department, a user e-mail address, a user password, a user phone number, and similar information pertaining to the user. The list of authorized users is to include data of a type typically used to define and authorize a user, at least some of which may overlap with the data type(s) listed in the directory of active network users. Such overlapping data may include, for example and without limitation, a user name, a user company, a user group or department, and similar information.

The list of authorized users is also to include user device information for computing devices, data processing devices, communications devices, and similar devices which a user may use. The user device information may include, for example and without limitation, a MAC (media access control address) for a device, or a port connection identification for a device. For each user in the list of authorized users, associated user device information, such as MAC address(es), may be listed as well, indicating the hardware device(s) is/are associated with the user.

In addition to permitting the user to register a user device in the database of authorized users, the user is further permitted to request that the user device should be removed from the database of authorized users. According to one or more examples discussed herein, when the user requests that the user device be removed from the database of authorized users, the user information and the user device information may be maintained in the database while an indication may be stored in the database marking the user device for deletion. Thus, if a request is made to newly register the user device, access may be determined based on the stored user information of the user device marked for deletion.

A user device may be physically coupled to the network, for example through a network switch. At substantially the same time that the user device is coupled to the network, the network receives from the user device the user device information, for example, a MAC address, through an automated device handshake process. If this user device information is currently listed in the list of authorized users, the user device is considered authorized and is granted access to the network. However, if the user device information is not listed in the list of authorized users, the user may be presented with an interface for entry of user self-registration information. The interface may be a graphical user interface, and may be presented via the user device, which has been coupled to the network, but may be presented via other devices as well. The user interface presents data fields or other sections for the entry of user information including, for example and without limitation, a user name, a user password, a user company, a user group, and similar information.

According to an example, a network device receives the user self-registration information and determines whether the user self-registration information is listed in the directory of active network users. If the user is listed in the directory of active network users, the hardware self-identification information is listed in the list of authorized users, and the user device is granted network access. As a result, when the user device is physically coupled to the network on future occasions, the user device information need not be requested again because the user device information is automatically recognized as being listed in the list of authorized users, and the user device is automatically granted network access.

Further, a real-time monitor may be maintained on the directory of active network users and any changes made by system and/or domain administrators to the directory of active network users may automatically result in appropriate changes to the list of authorized users, and to network access for the associated devices listed in the list of authorized users. This further simplifies network access security and control for system and/or domain administrators.

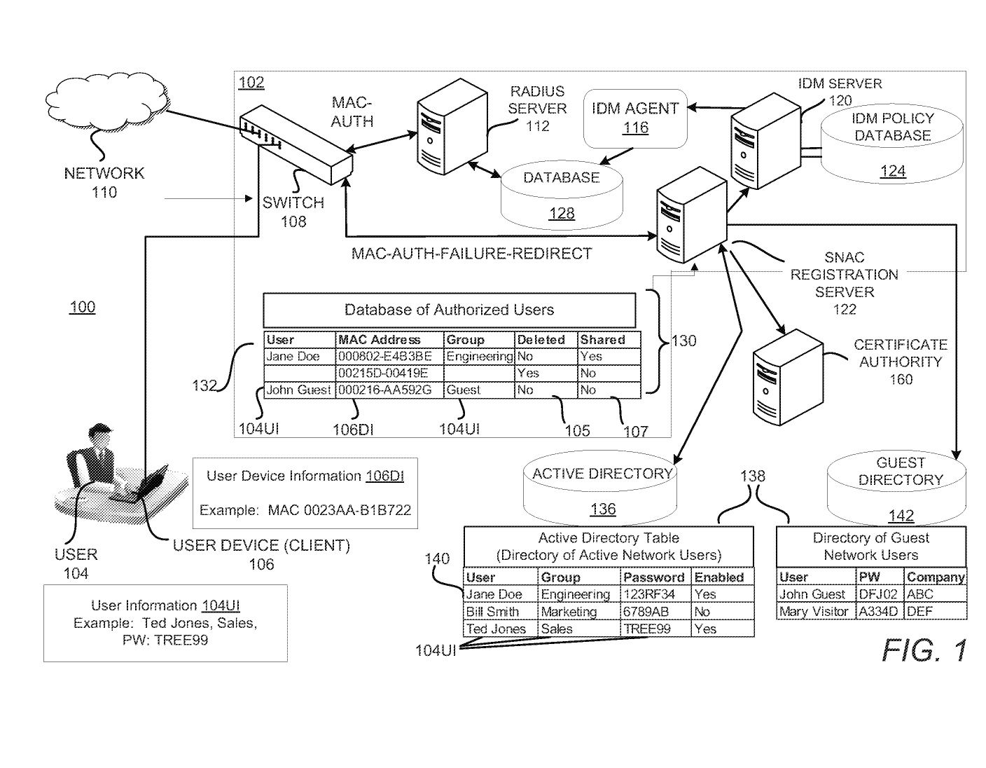

With reference to FIG. 1, there is shown a functional block diagram of an environment 100, in which a network device for managing access to a network 110 by a user device 106 may be implemented, according to an example. It should be readily apparent that the diagram depicted in FIG. 1 represents a generalized illustration and that other components may be added or existing components may be removed, modified or rearranged without departing from a scope of the environment 100.

FIG. 1 depicts a system 102, which may be referred to as a Simplified Network Access Control (SNAC) system, but other names may be employed as well. The system 102 is depicted as including a network switch 108, an Identity Driven Manager (IDM) server 120 for hosting IDM modules (not shown), a SNAC registration server 122 for hosting SNAC modules (not shown). In addition, the SNAC registration server 122 is depicted as being in communication with an Active Directory (AD) 136 and a guest directory 142. The network switch 108 is also depicted as being in communication with a network 110, which may include network servers and devices.

FIG. 1 also depicts a user device 106, also known as a client or network client 106. User devices 106 are used by users 104, who are people or other entities seeking to log into and access the network 110. A user 104 seeking to utilize resources of a network 110 will connect their user device 106 to the switch 108 or other connection element, such as a wireless access point (not shown). Associated with the user 104 is user information 104UI. Associated with the user device 106 is user device information 106DI.

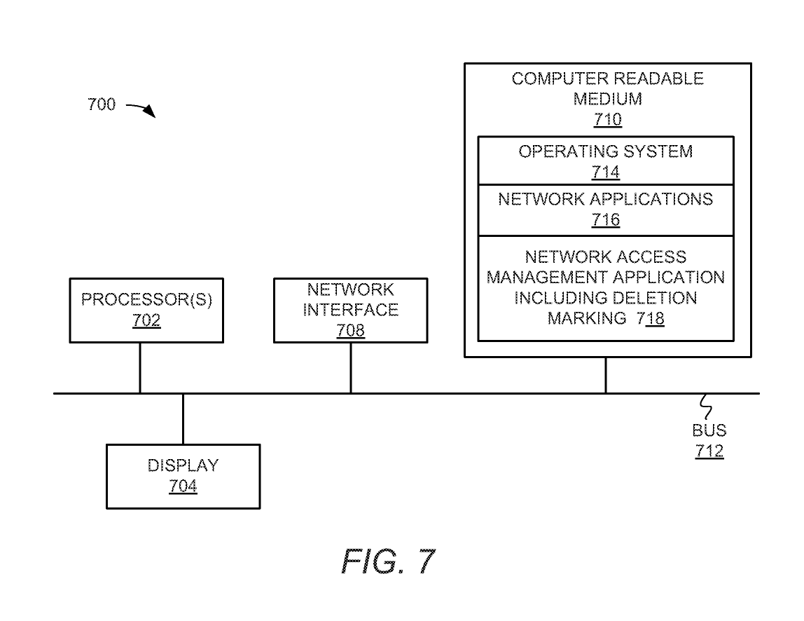

The switch 108 is depicted as communicating with a Remote Authentication Dial In User Service (RADIUS) server 112, in which the switch 108 operates as a RADIUS client. More particularly, the RADIUS server 112 may employ RADIUS, which is a networking protocol that provides authentication, authorization, and accounting management for network access, for instance, as described in RFC 2865 and 2866. In addition, the switch 108 may operate as a RADIUS client to the RADIUS server 112. The RADIUS server 112 is also depicted as being in communication with a database of authorized users 128, which may host a list of authorized users 130. An example list of authorized users 130 is depicted in FIG. 1 to include fields for a user name, a MAC address, a user group, an indication whether the user device is marked for deletion 105, optionally, whether a device is a shared device 107, etc. The Database of Authorized Users may be more fully discussed with regard to FIG. 7. According to an example, a user device 106 attempting to gain access to the network 110 may be denied access to the network 110 unless the user device information 106DI of the user device 106 is listed in the list of authorized users 130 and is not marked for deletion.

An IDM agent 116, which provides management for an IDM policy database 124, is also depicted as being in communication with the database of authorized users 128. In addition, the IDM agent 116 is depicted as being in communication with the IDM server 120, which may host an IDM policy database 124. The IDM policy database 124 may contain a variety of tables and data defining user access rights and user access policies for various network users 104 and user devices 106.

According to other examples, the RADIUS server 112 and/or the IDM agent 116 may be hosted on the switch 108 or hosted on the IDM server 120, or on a combination of both. In addition, or alternatively, the RADIUS server 112 and/or the IDM agent 116 may be hosted on the SNAG registration server 122. As a further example, the IDM server 120 and the SNAC registration server 122 may comprise a common server and the RADIUS server 112 and/or the IDM agent 116 may be hosted on the common server.

The Active Directory 136 is depicted as including a directory table of active network users 138. The Active Directory 136 may be populated by an administrator, and functions to list users who are currently considered as having an active or valid association with a network 110. An example Active Directory table 138 is depicted in FIG. 1, which may have at least one data field or data type in common with the list of authorized users 130, or may have pointers or similar arrangements, to associate users 140 in the Active Directory table 138 with users 132 in the list of authorized users 130. In FIG. 1, the list of authorized users 130 and the Active Directory table 138 have in common two user fields 104UI, the User field and the Group field. In this way, it is possible to identify in the Active Directory table 138 a user who may potentially be listed for entry in the list of authorized users 130.

In FIG. 1, for example, both Jane Doe 132 and Jane Doe 140 are the same user listed in the respective list of authorized users 130 and the Active Directory table 138. The Active Directory table 138 may also include additional identifying information, which may be used to validate a user during a self-registration or login process. For example, the Active Directory table 138 is depicted as containing a password field, which may in part contribute to verifying a user who is attempting to access the network 110. The Active Directory table 138 may also contain a field or flag to indicate if a user listing is currently enabled. If enabled, the user is allowed network access. If disabled, the user is denied network access. This may be used to temporarily disable network access without a need to delete all user information 104UI. Other fields and flags (not shown) may also be employed to determine other aspects of network access for a user or user group.

According to an example, the switch 108 may be a conventional switch, which is not configured to host or support the RADIUS server 112 or the IDM agent 116. In such a case, the RADIUS server 112, the database of authorized users 128, and the IDM agent 116 may all be hosted on the SNAC registration server 122 and/or the IDM server 120. In an alternative example, the RADIUS server 112, the IDM agent 116, the database of authorized users 128, and the IDM policy database 124 may all be hosted on the switch 108. Therefore, the system 102 as depicted in FIG. 1, including the switch 108, the SNAC registration server 122, the IDM server 120, may instead include one of the switch 108, the SNAG registration server 122, or the IDM server 120 without the other components.

It should be further noted that the boundaries of the system 102, as suggested by the outlined area in FIG. 1, are example boundaries only. For example, the Active Directory 136 and/or the Guest Directory 142 may be considered part of the system 102.

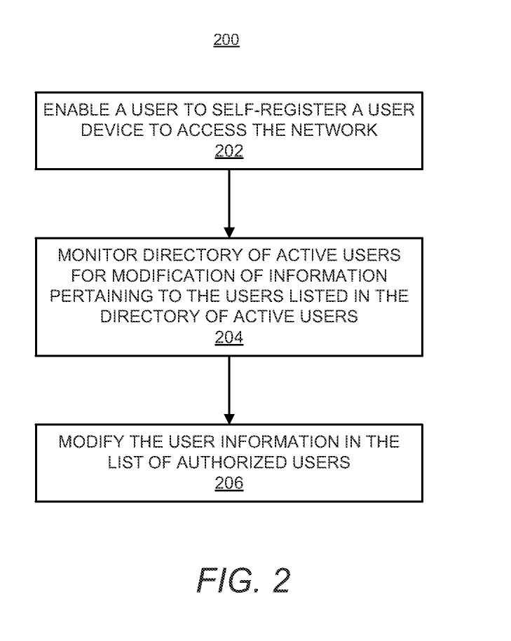

Various manners in which a simplified network access control management operation may be implemented are discussed with respect to the methods 200-400, respectively depicted in FIGS. 2-4. It should be readily apparent that the methods 200-400 depicted in FIGS. 2-4 represent generalized illustrations, and that other processes may be added or existing processes may be removed, modified or rearranged without departing from the scope and spirit of the methods 200-400.

Generally speaking, the various operations depicted and discussed with respect to FIGS. 2-4 and 6 may be implemented by at least one of the components of the system 102 depicted in FIG. 1. Thus, for instance, the switch 108, the SNAC registration server 122, or the IDM server 120, or a combination of these components may implement each of the operations depicted in FIGS. 2-4 and 6. In this regard, the methods 200-400 and 600 may comprise machine-readable instructions stored on any one or more of the switch 108, the SNAC registration server 122, the IDM server 120, and a combination of these components. In addition, or alternatively, the methods 200-400 and 600 may comprise machine-readable instructions stored on a non-transitory computer readable storage medium that is implemented or executed by any one or more of the switch 108, the SNAG registration server 122, the IDM server 120, and a combination of these components.

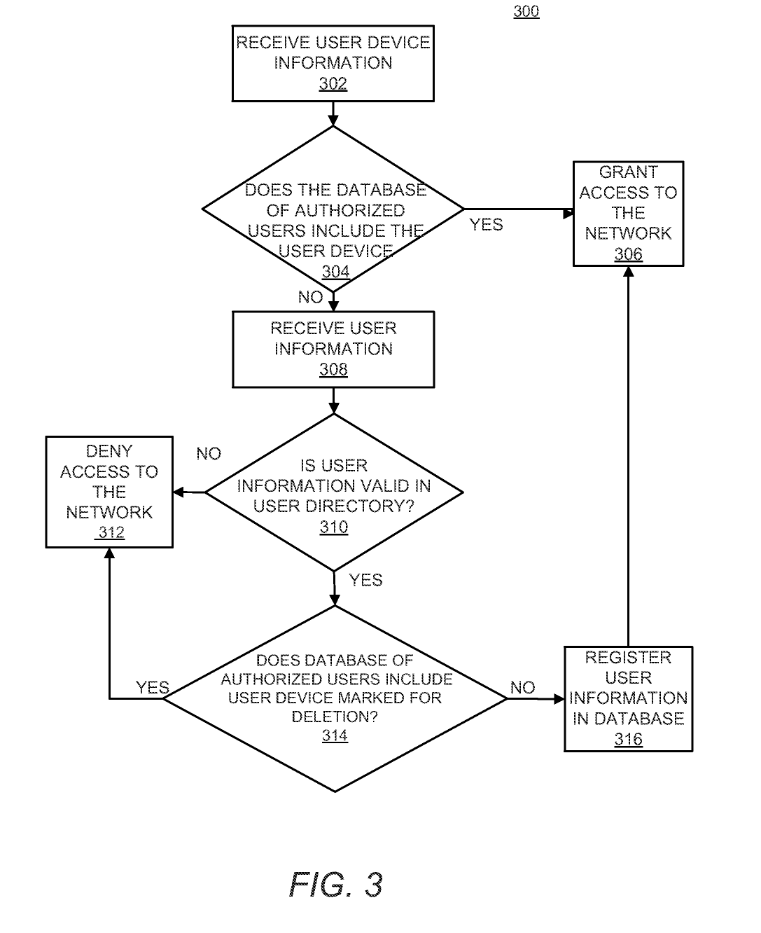

With reference first to FIG. 2, there is shown a flow diagram of a method 200 for managing access to a network 110, according to an example. At block 202, a user 104 is enabled to self-register a user device 106 into a database of authorized users 128 to access the network 110 in response to the user 104 being listed as a valid user in a directory of active network users 136, 142. According to an example, the self-registration is enabled through a MAC based authentication operation. Various manners in which the self-registration operation may be implemented are described in greater detail herein below with respect to the method 300 in FIG. 3.

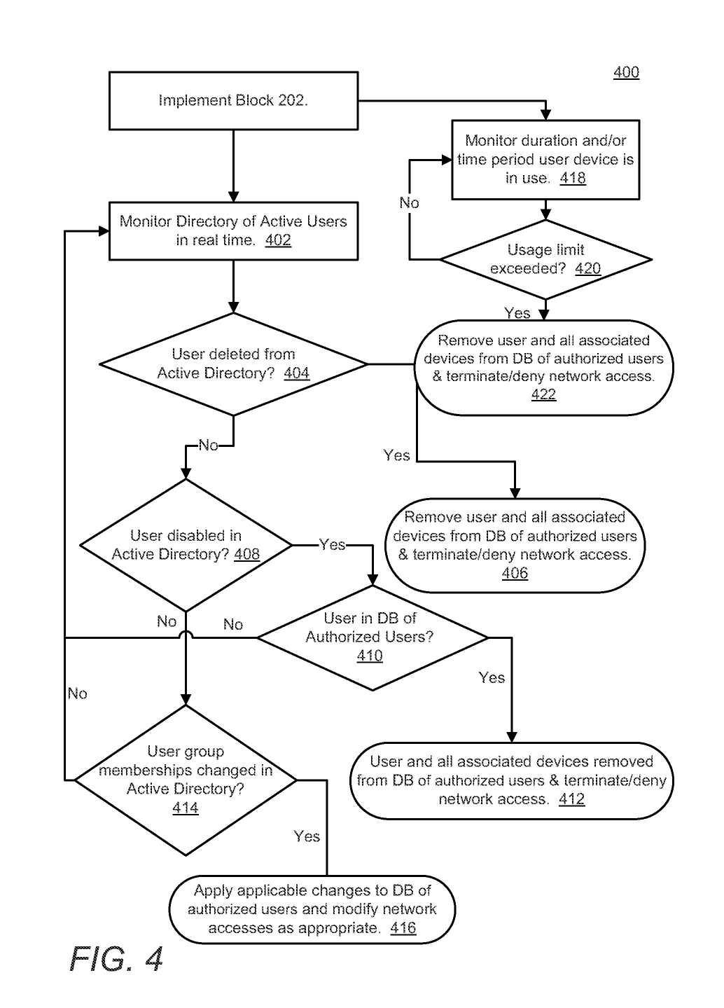

At block 204, the directory of active network users 136, 142 is monitored for modification of information pertaining to the users listed in the directory of active network users 136, 142. As discussed above, the directory of active network users may comprise one or both of the active directory 136 and the guest directory 142. In addition, various manners in which the directory of active network users 136, 142 may be monitored are described in greater detail herein below with respect to the method 400 in FIG. 4.

At block 206, the database of authorized users 128 is modified in response to a determination that the user information pertaining to at least one user listed in the directory of active network users 136, 142 that affects the database of authorized users 128 has been modified. Various manners in which the database of authorized users 128 maybe modified based upon modifications to the directory of active network users 136, 142 that affect the user information contained in the database of authorized users 128 are also described in greater detail herein below with respect to the method 400 in FIG. 4.

Turning now to FIG. 3, there is shown a flow diagram of a method 300 for enabling a user to self-register a user device into a database of authorized users 128 to access the network 110, according to an example. The method 300 generally comprises a more detailed description of the operations that may be performed at block 202 in FIG. 2.

At block 302, user device information 106DI of the user 104 requesting access to the network 110 is received. The user device information 106DI may be, for instance, the MAC address of the user device 106. In addition, the user device 106 may automatically communicate the user device information 106DI to the switch 108 when the user device 106 is coupled to the switch 108, for instance, during a handshake operation between the switch 108 and the user device 106.

More generally, the user device information 106DI may comprise a set of data associated with the user device 106 and may serve to uniquely identify the user device 106 to the network 110. In some cases, redundant or additional information may be employed, or added, in order to further identify the user device 106 or to limit, control, or constrain the association of the user device 106 with the network 110. For example, a port identifier on the switch 108 may be combined with the MAC address of the user device 106 to form a combined or multi-signature user device information 106DI. Similarly, a specific frequency or channel may be associated with a wireless device in order to form a combined or multi-signature user device information 106DI. In some cases, however, some leeway may be granted in assigning a user device information 106DI. For example, a wireless user device 106 may still be granted access to the network 110 if it is associated with two or more wireless access points (that is, wireless switches 108), provided those multiple access points are substantially in proximity to each other.

At block 304, a determination as to whether the database of authorized users 128 includes the user device information 106DI, and whether it is marked for deletion, is made. As shown in FIG. 1, and according to an example, the switch 108 is to implement the RADIUS server 112 (“MAC-AUTH” line) in making the determination as to whether the database of authorized users 128 includes the user device information 106DI. Alternatively, however, the SNAC registration server 122 and/or the IDM server 120 may make this determination.

In response to a determination that the database of authorized users 128 does include the user device information 106DI, and it is not marked for deletion, access to the network 110 is granted to the user 104 through the user device 106, as indicated at block 306. Specific access and control rights may be determined by IDM agent 116 in conjunction with IDM policy database 124. However, if a determination that the database of authorized users 128 does not include the user device information 106DI, at block 308, user information 104UI is received at block 308. More particularly, for instance, the user 104 may be prompted to input the user information 104UI, such as, a user name, user identification, password, and/or other credentials, and the user 104 may input the requested user information 104UI. In addition, the switch 108 may redirect the user information 104UI to the SNAG registration server 122 as indicated by the line labeled “MAC-AUTH-FAILURE-REDIRECT”.

At block 310, a determination as to whether the user information 104UI is valid in the directory of active network users 136, 142 is made, for instance, by the SNAC registration server 122 following receipt of the user information 104UI. Thus, for instance, a determination as to whether the user information 104UI is contained in the directory of active network users 136, 142 is made and if so, whether the user 104 has inputted the correct credentials, for instance, the correct password, and is enabled to access the network 110 is made. By way of example, and as shown in FIG. 1, the active directory table 138 contained in the active directory 136 shows that the user “Jane Doe” is enabled to access the network 110 and that here password is “123RF34”. It will be noted that the Active Directory 136, Guest Directory 142, or similar directories of active network users are typically populated, maintained, and updated by an authorized administrator or other person(s) responsible for ensuring legitimate network access. For example, an authorized organizational staff member may be designated to populate Guest Directory 142 with names and other identifying information 104UI for network users 104 who will be guests, and who will therefore be permitted guest or temporary access to the network 110.

In response to a determination that the user information 104UI supplied by the user at block 308 is invalid, access to the network 110 is denied as indicated at block 312. Thus, if the user information 104UI is not contained in the directory of active network users 136, 142, if the user information 104UI, for instance, the password, does not match the user information 104UI contained in the directory of active network users 136, 142, and/or if the user's 104 network access has been disabled, access to the network is automatically denied at block 312. In addition, suitable additional steps may be taken. For example, a user 104 may prompted to re-enter user information 104UI (on the possibility that the information was entered incorrectly a first time), or an alert may be sent to an administrator or designated organizational administrator. Policies for responding to an incorrect or erroneous user information 104UI may be defined in IDM policy database 124, and implemented by processes such as RADIUS server 112 and/or IDM agent 116.

In response to a determination that the user information 104UI supplied by the user at block 308 is valid, at block 314, a determination is made whether the database of authorized users includes the user device information with an indication that the user device was marked for deletion. If the database of authorized users has stored therein the user device information with an indication that it is marked for deletion, the user device, at block 312, is denied access to the network. Optionally, suitable additional steps may be taken. For example, an message may be generated and transmitted to an administrative device, administrator or designated organizational administrator, etc. The message may indicate that an unauthorized access was attempted by the user device. Policies for responding to an unauthorized access in this regard may be defined in IDM policy database 124, and implemented by processes such as RADIUS server 112 and/or IDM agent 116.

At block 314, if a determination is made that the database does not include the user device, the user information 104UI is registered into the database of authorized users 128, as indicated at block 316. In other words, the user information 104UI is automatically populated into the list of authorized users 130 in the database of authorized users 128. In this regard, the user 104 may be granted access to the network 110 through the user device 106, at block 306, without requiring the direct support or intervention of an administrator. From the perspective of the user 104, the self-registration operation of the method 300 may be implemented via a log-in process and log-in displays.

In addition, along with the user information 104UI, and associated with it, is added the user device information 106DI for the device 106. If the user 104 is already present in the list of authorized users 130 (indicating another user device 106 is already associated with the user 104), then newly added device 106 and its user device information 106DI may also be associated with the same user 104. In an example, when the user information 104UI is added to the list of authorized users 130, all of the provided user information 104UI is added. In another example, when the user information 104UI is added to the list of authorized users 130, only a subset of the user information 104UI is added.

In addition, the user 104 is granted access to the network 100 as indicated at block 306, which has been described herein above.

By way of particular example, once the user's credentials are verified and the user 104 is determined to be a valid user at block 310, the SNAC registration server 122 adds the user information 104UI to the IDM server 120. In addition, the IDM server 120 pushes the user information 104UI to all of the IDM agents 116. An IDM agent 116 registers the user information 104UI into the database of authorized users 128 as discussed above. Subsequent access to the network 110 through the user device 106 will now occur automatically as the user 104 is immediately allowed access with the appropriate access rights based on the their IDM group, profile, etc. In addition, from this point forward, the user 104 is unaware that SNAC is being implemented since the user's 104 access to the network 110 through the user device 106 is transparent to the user 104. As discussed in greater detail below with respect to the method 400 in FIG. 4, when the user's access rights changes, such as, when the user leaves a company, that change is automatically reflected in the database of authorized users 128 since the IDM server 120 is monitoring the directory of active network users 136, 142 for changes.

With reference now to FIG. 4, there is shown a flow diagram of a method 400 for ongoing management of a user 104 and user device 106 already granted access to a network 110 as per the method 200 discussed above. The method 400 generally comprises a more detailed description of the operations that may be performed at blocks 204 and 206 in FIG. 2. In this regard, the method 400 may be implemented following implementation of block 202. In addition, the method 400 may involve a single process, or may involve multiple processes occurring substantially in parallel or in alternating sequence. FIG. 4 depicts two processes. According to an example, the SNAC registration server 122 and/or the IDM server 120 implements various operations in the method 400.

In a first process starting at block 402, the directory of active network users 136, 142 is monitored in substantially real time, on a substantially continuous or frequent basis. At decision block 404, a determination is made as to whether a user 104 has been deleted from the directory of active network users 136, 142. Such a deletion may be made by an administrator or other person or entity authorized to control access to the network 110.

If a user 104 has been deleted, at block 406, any record or similar listing of the user 104 in the database of authorized users 128 is deleted, as is the listing of any associated user device information 106DI from the listing of authorized users 130. This effectively prevents these user devices 106 from logging into the network 110 in the future, as per methods 200/300 discussed above. In addition, if any of the deleted user devices 106 are currently connected to the network 110, their network connection may be terminated.

If, however, at decision block 404, a determination is made that the user 104 is still listed in the directory of active network users 136, 142, at block 408, a determination is made if the user 104 has been disabled in the directory of active network users 136, 142. Such a status may be set by an administrator or other person or entity authorized to control access to the network 110.

If a user 104 has had their activity status set to disabled, at block 410, a determination is made if any user devices 106 for the user 104 are currently contained in the database of authorized users 128. If yes, at block 412, and according to an example, if any such user devices 106 currently have active network connections, their network connection is terminated. In addition, the user information 104UI and user device information 106DI are deleted from the list of authorized users 130 contained in the database of authorized users 128. In another example, instead of the user information 104UI and user device information 106DI being deleted from the database of authorized users 128, a flag may be set in the list of authorized users 130 indicating that the user device(s) 106 are not currently authorized to access the network 110. This may prevent the user devices 106 from being logged into the network 110 during the method 200 and may trigger the self-registration process of the method 300. If, however, at block 410, the user 104 is not listed in the database of authorized users 128, then no specific action is required with respect to the database of authorized users 128, and monitoring continues as per block 402.

If at decision block 408, a determination is made that a user 104 remains active in the directory of active network users 136, 142, at block 414, a determination is made as to whether any other aspects of parameters for the user 104 have been changed in the directory of active network users 136, 142. If yes, at block 416, appropriate changes are made to the database of authorized users 128, and user device 106 network access or network privileges may be modified as appropriate. For example, network access privileges may be increased or decreased, access domains changed, network control authority changed, and other changes made as appropriate. Some changes may be determined based on changes in the directory of active network users 136, 142 in conjunction with policies set in IDM policy database 124, as appropriate.

In an example second process starting at block 418, a user time limit and/or date limit set in the directory of active network users 136, 142 is noted, and the appropriate time and or date is monitored. For example, a date limit may indicate that a user 104 is only entitled to access to the network for a specific date, such as May 1. The current date is determined, as well as whether or not the corresponding user device 106 is in use.

At decision block 420, a determination is made if the user time limit or user date boundaries have been exceeded. If yes, then at block 422 network access through the user device 106 is terminated by removing the user information 104UI and the associated user device information 106DI are deleted from the list of authorized users 130 in the database of authorized users 128, preventing future logins through the user device 106.

It may be appreciated that, in some embodiments, alternative to removing the user and associated devices from the database of authorized users and terminate/deny network access, the user and associated devices may be put into a less privileged access profile or group.

In general, the methods 200-400 may be implemented to determine if more than one user device 106 with a same user device information, or a single device with an erroneous user device information, attempts to connect to the network 110. In such cases, an alert may be sent to an administrator indicating that an attempt at device spoofing may be in progress, and one or more user devices 106 may be denied access or have existing access challenged. Specific policies to detect spoofing and other erroneous self-identifications may be defined on IDM policy database 124, and implemented by IDM agent 116.

Some or all of the operations set forth in the methods 200-400 may be contained as a utility, program, or subprogram, in any desired computer accessible medium. In addition, the methods 200-400 may be embodied by computer programs, which may exist in a variety of forms both active and inactive. For example, they may exist as machine-readable instructions, including source code, object code, executable code or other formats. Any of the above may be embodied on a computer readable storage medium.

Examples of non-transitory computer readable storage media include conventional computer system RAM, ROM, EPROM, EEPROM, and magnetic or optical disks or tapes. Concrete examples of the foregoing include distribution of the programs on a CD ROM or via Internet download. It is therefore to be understood that any electronic device capable of executing the above-described functions may perform those functions enumerated above.

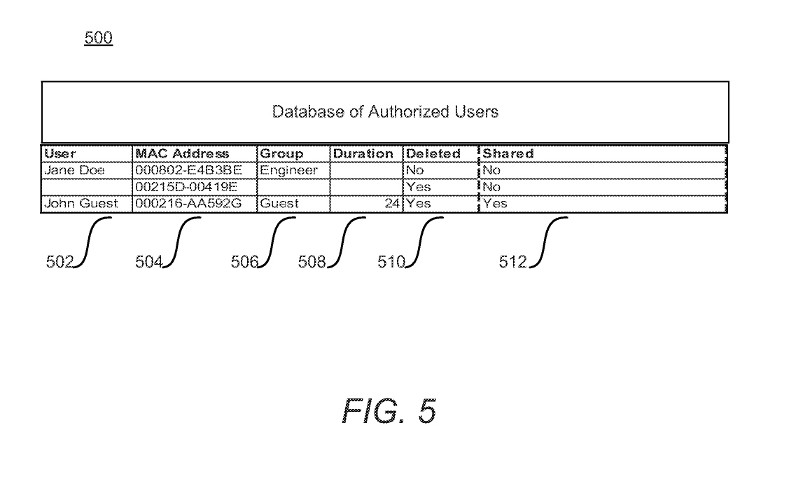

FIG. 5 depicts an example database of authorized users according to an example of the present disclosure. As noted above the database of authorized users 500 may include information associated with users that are authorized to access the network. The database of authorized users may include fields for storing information associated with an authorized user. For example, the database a user name 502, a MAC address 504, a user group 506, and a duration of network access 508.

The database of authorized users may further include an indication wither the user device has been deleted 510. As discussed herein, the user may manage devices that have been registered and thus, are permitted access to the network. Management of the user devices may provide for the user to request deletion of the user device from the database of authorized users. If a request is received to remove a user device from the database of authorized users, instead of deleting the user device, and information associated with the user device, from the database of authorized users, an indication may be made in the deleted field 510 that the user device is marked for deletion. As can be seen in FIG. 5, at 510, MAC address 00215D-00419E and MAC address 000216-AA592G have been marked as deleted. By maintaining this information in the database of authorized users, the system may know if different user attempts to register the same user device in the network, thus preventing a potential unauthorized access to the network.

Optionally, the database of authorized users may further include an indication whether the user device is a shared device 512. In some organizations, it is common for different users to use a shared device. By maintaining information in the database regarding whether the device is a shared device, the system may keep track of when a shared device is registered and which user is using the shared device.

It may be appreciated that a report may be generated by a server, relating to user devices that have been deleted. For example, a report may be generated that identifies all user device that have been marked as deleted for a predetermined period of time, for example, 1 month, 1 year, etc. The generated report may be transmitted to an administrative device. This may enable an administrator to review the report and permanently delete the user devices from the database of authorized users, for example, in order to free space in the database. It may further be appreciated that user devices may be automatically deleted after a predetermined period of time.

It may be appreciated that a server may search the database of authorized users and determine that a user device, that is not marked for deletion, has not accessed the network for a predetermined period of time. The server may generate a message to the user of the user device, requesting update information regarding the user device's status in the network. For example, if the user device is no longer going to access the network, the user may be instructed to remove the user device from the database of authorized users. The generated message may then be transmitted to an address, for example, an email address, etc., that is stored and associated with the user of the user device.

It may be appreciated that the information stored in database 500 may be stored in a single database, or in multiple databases at the same device or at difference devices. It may further be appreciated that additional information related to the user and the user device may be stored in database 500.

It may further be appreciated that, alternatively, the database 500 may store information relating to how much time is left until the re-verification process is initiated.

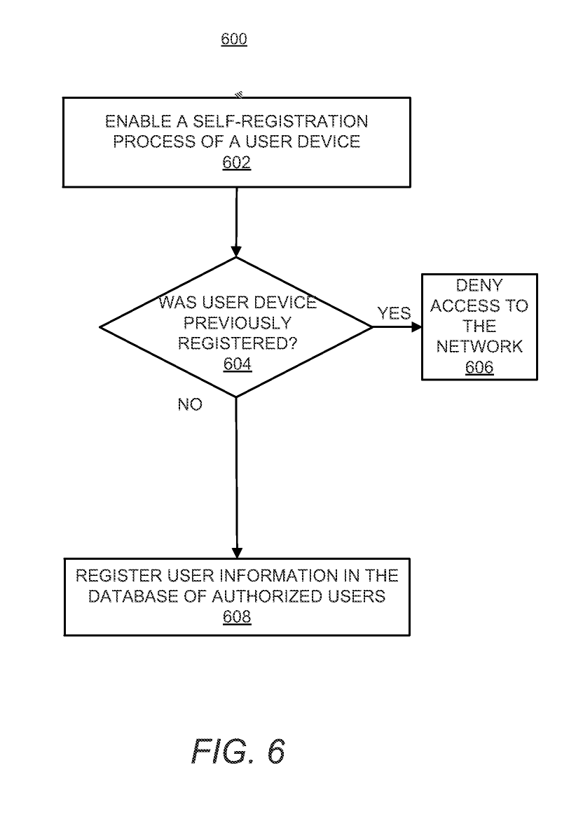

FIG. 6 graphically illustrates an example flow diagram of a self-registration process. At block 602, a server, for example, a SNAC registration server, may enable a self-registration process of a user device attempting to gain access to a network. This may be enabled where a user device transmits user device information to the server. At block 604, the server determines whether the user device was previously registered. For example, the server may access the database of authorized users in order to determine, by searching for, for example, the MAC address of the user device in the database. If the user device was in the database and, in association with the user device, an indication stored that the user device was marked for deletion (block 604, YES), at block 606, access to the network may be denied. If the user device was not registered and stored in the database (block 604, NO), at block 608, the server may register the user information in the database of authorized users. After registration, the user device may be granted access to the network.

Turning now to FIG. 7, there is shown a schematic representation of a computing device 700, which may be employed to perform various functions of the servers 120, 122 depicted in FIG. 1, according to an example. Similar elements, possibly with some elements omitted or added, may also be employed within an intelligent switch, such as switch 108 in FIG. 1. Computing device 700 includes a processor 702; a display device 704, such as a monitor; a network interface 708, such as a Local Area Network LAN, a wireless 802.11x LAN, a 3G mobile WAN or a WiMax WAN; and a computer-readable medium 710. Each of these components is operatively coupled to a bus 712. For example, the bus 712 may be an EISA, a PCI, a USB, a FireWire, a NuBus, or a PDS.

The computer readable medium 710 may be any suitable non-transitory medium that participates in providing instructions to the processor 702 for execution. For example, the computer readable medium 710 may be non-volatile media, such as an optical or a magnetic disk; volatile media, such as memory; and transmission media, such as coaxial cables, copper wire, and fiber optics. Transmission media can also take the form of acoustic, light, or radio frequency waves. The computer readable medium 710 may also store other machine-readable instructions, including word processors, browsers, email, Instant Messaging, media players, and telephony machine-readable instructions.

The computer-readable medium 710 may also store an operating system 714, such as Mac OS, MS Windows, Unix, or Linux; network applications 716; and a network access management application/re-verification timer 718. The operating system 714 may be multi-user, multiprocessing, multitasking, multithreading, real-time and the like. The operating system 714 may also perform basic tasks such as recognizing input from input devices, such as a keyboard or a keypad; sending output to the display 704; keeping track of files and directories on the computer readable medium 710; controlling peripheral devices, such as disk drives, printers, image capture device; and managing traffic on the bus 712. The network applications 716 include various components for establishing and maintaining network connections, such as machine-readable instructions for implementing communication protocols including TCP/IP, HTTP, Ethernet, USB, and FireWire.

The network access management application 718 provides various components for managing access to a network and implementing deletion marking, as described above with respect to the methods FIGS. 2-6. The network access management application including deletion marking 718, when implemented, receives on a network device 108/120/122 a user device identification 106DI from a user device 106 requesting access to the network 110. The network access management application 718, when implemented, further enables a user 104 to self-register the user device 106 into a database of authorized users 128 in response to the user being listed as a valid user in a directory of active network users 136, 142. In addition, the network access management application 718, when implemented, monitors the directory of active network users 136, 142 for modification of information pertaining to the users listed in the directory of active network users 136, 142. Moreover, the database of authorized users 128 is modified in response to a determination that user information pertaining to at least one user listed in the directory of active network users 136, 142 that affects the database of authorized users 128 has been modified. In addition, where a user deletes a user device from the database of authorized users, the user device may be marked as deleted, where the user device remains in the database in order to ensure a different user does not register the same device in the network, thereby avoiding an unauthorized network access. In certain examples, some or all of the processes performed by the network access management application 718 may be integrated into the operating system 714. In certain examples, the processes may be at least partially implemented in digital electronic circuitry, or in computer hardware, machine-readable instructions (including firmware and/or software), or in any combination thereof.

Although described specifically throughout the entirety of the instant disclosure, representative embodiments of the present disclosure have utility over a wide range of applications, and the above discussion is not intended and should not be construed to be limiting, but is offered as an illustrative discussion of aspects of the disclosure.

What is claimed is:

1. A method, comprising:
implementing a media access control (MAC) based authentication operation in determining whether to grant a user device of a user access to a network;
enabling the user to self-register the user device into a database of authorized users to access the network in response to the user being denied access to the network through the MAC based authentication operation and being listed as a valid user in a directory of active network users;
receiving credentials of the user and verifying the credentials of the user with stored credentials associated with the user;
determining if the user device was previously registered and marked for deletion; and
if the user device was previously registered and marked for deletion, denying the user device access to the network.

2. The method of claim 1, further comprising:
if the credentials of the user are verified, and the user device was previously registered and not marked for deletion, granting the user device access to the network.

3. The method of claim 1, further comprising:
if the user device is denied access to the network, generating and transmitting a message to an administrative device indicating that a previously registered device that was marked for deletion attempted to gain access to the network.

4. The method of claim 1, wherein if the user device was previously registered and marked for deletion, denying the user device access to the network further includes:
determining if the user device is a shared device; and
if the user device is not the shared device and if the user device was previously registered and marked for deletion, denying the user device access to the network.

5. The method of claim 1, wherein the step of if the user device was previously registered and marked for deletion, denying the user device access to the network further includes:
determining if the user device is a shared device; and
if the user device is the shared device and if the user device was previously registered and marked for deletion, granting the user device access to the network and updating a memory with identifying information of the user of the user device.

6. An apparatus, comprising:
a memory, storing a set of instructions; and
a processor, to execute the stored set of instructions, to perform a network access management method, including:
receive a request to remove a user device from a database of authorized users of a network; and
upon receipt of the request to remove the user device, maintain stored information related to the user device in the database, and store an indication, associated with the stored information related to the user device, that the user device is marked as deleted.

7. The apparatus of claim 6, the processor further to:
receive a request from the user device to access the network, the request including user information;
determine if the user device was previously registered;
if it is determined that the user device was previously registered, determine if the information related to the user device was marked as deleted; and
if it is determined that the user device was marked as deleted, and the stored user information associated with the user device is different than the user information included in the request, deny network access to the user device.

8. The apparatus of claim 7, the processor further to:
determine if the user device was a shared device; and
if the user device was not a shared device, and if it is determined that the user device was marked as deleted, and if the stored user information associated with the user device is different than the user information included in the request, deny network access to the user device.

9. The apparatus of claim 7, the processor further to:
if it is determined to deny access, generate an alert indicating that the user device was previously registered by a different user and has requested access to the network.

10. The apparatus of claim 6, the processor further to:
generate a report of all user devices that have been marked as deleted in the database for a predetermined period of time; and
transmitting the report to an administrative device.

11. The apparatus of claim 6, the processor further to:
determine that the information related to the user device that is stored in the database has not accessed the network for a predetermined period of time;
generate a message to the user of the user device requesting update information regarding the user device's status in the network; and
transmit the message to an address of the user of the user device stored in association with the information related to the user device.

12. A non-transitory computer readable storage medium on which is embedded a computer program, said computer program implementing a method of network access management, said computer program comprising computer readable code to:
enable a self-registration process of a user device into a database of authorized users to access the network in response to the user being listed as a valid user in a directory of active network users;
during the self-registration process, determine if the user device was previously registered and marked for deletion; and
during the self-registration process, permit access to the network if the user device was not previously registered and marked for deletion.

13. The non-transitory computer readable storage medium of claim 12, the computer readable code to further:
where the user device was previously registered and marked for deletion, determine if the user registering the user device is a different user from the user associated with the previously registered user device; and
deny access to the network if the user registering the user device is different from the user associated with the previously registered user device.

14. The non-transitory computer readable storage medium of claim 13, the computer readable code to further:
generate a message to an administrative device indicating that an improper access to the network was attempted by the user device; and
transmit the generated message.

15. The non-transitory computer readable storage medium of claim 13, the computer readable code to further:
determine if the user device is a shared device; and
if the user device is not the shared device and if the user device was previously registered and marked for deletion, deny the user device access to the network.

16. The non-transitory computer readable storage medium of claim 12, the computer readable code to further:
determine if the user device is a shared device; and
if the user device is the shared device, permit registration of the user device and update a memory with user information of the user device.
